(19) United States
(12) Patent Application Publication
(10) Pub. No.: US 2014/0347904 A1
(43) Pub. Date: Nov. 27, 2014

(54) POWER CONVERTER

(71) Applicant: Masahiro Kinoshita, Chuo-ku (JP)

(72) Inventor: Masahiro Kinoshita, Chuo-ku (JP)

(73) Assignee: TOSHIBA MITSUBISHI-ELECTRIC INDUSTRIAL SYSTEMS CORPORATION, Chuo-ku, Tokyo (JP)

(21) Appl. No.: 14/371,812

(22) PCT Filed: Feb. 3, 2012
(86) PCT No.: PCT/JP2012/052500

§ 371 Date: Jul. 11, 2014

(51) Int. Cl. H02M 7/06

(52) U.S. Cl. CPC H02M 7/06
USPC 363/126

(57) ABSTRACT

A power converter comprises a first diode, a second diode, a first capacitor, a second capacitor, and an AC switch. The first diode has a cathode terminal connected to a DC positive bus. The second diode has a cathode terminal connected to an anode terminal of the first diode, and an anode terminal connected to the DC negative bus. The first capacitor is connected between the DC positive bus and a neutral point. The second capacitor is connected between the DC negative bus and the neutral point. An AC switch is connected between the connection point of the first and second diodes, and the neutral point.

### TECHNICAL FIELD

The present invention relates to power converters.

### BACKGROUND ART

A rectifier circuit is one kind of a power converter. A variety of rectifier circuits have thus far been suggested. The rectifier circuit disclosed in Japanese Patent Laying-Open No. 2006-211867 (PTD 1), for example, includes a plurality of diode bridges, a capacitor, and a switching element. DC positive terminals and DC negative terminals of the respective diode bridges are commonly connected between the plurality of diode bridges. The capacitor and the switching element are connected in parallel between the DC positive terminals and the DC negative terminals of the diode bridges.

Japanese Patent Laying-Open No. 2007-329980 (PTD 2) and Japanese Patent Laying-Open No. 2002-142458 (U.S. Pat. No. 4,051,875 (PTD 3)), for example, each disclose a rectifier circuit including bidirectional switches. WO 2010/021052 A1 (PTD 4), for example, discloses the application of a three-level circuit to a power converter, in order to reduce the size and the weight of the power converter.

### CITATION LIST

### Patent Document

PTD 1: Japanese Patent Laying-Open No. 2006-211867

PTD 2: Japanese Patent Laying-Open No. 2007-329980

PTD 3: Japanese Patent Laying-Open No. 2002-142458 (U.S. Pat. No. 4,051,875)

PTD 4: WO 2010/021052 A1

### SUMMARY OF INVENTION

### Technical Problem

A semiconductor switching element contained in a power converter is a MOSFET (Metal Oxide Semiconductor Field Effect Transistor) or an IGBT (Insulated Gate Bipolar Transistor), for example. When loss is compared between a MOSFET and an IGBT having an equal rating, loss in the MOSFET is generally smaller than that in the IGBT.

A MOSFET has a parasitic diode due to its structure. In the case of a power converter including a MOSFET, a recovery current flows through the parasitic diode of the MOSFET in a recovery mode. If the recovery current is large, the MOSFET may be broken. For these reasons, many power converters use IGBTs to ensure the reliability of the power converters. In the case of a power converter including an IGBT, however, the efficiency is problematic.

One object of the present invention is to provide a power converter having high efficiency.

### Solution to Problem

In one aspect of the present invention, a power converter includes a first diode, a second diode, a first capacitor, a second capacitor, and an AC switch. The first diode has a cathode terminal connected to a DC positive bus. The second diode has a cathode terminal connected to an anode terminal of the first diode, and an anode terminal connected to a DC negative bus. The first capacitor is connected between the DC positive bus and a neutral point. The second capacitor is connected between the DC negative bus and the neutral point. The AC switch is connected between a connection point of the first and second diodes, and the neutral point.

### Advantageous Effects of Invention

According to the present invention, a power converter having high efficiency can be realized.

### BRIEF DESCRIPTION OF DRAWINGS

FIG. 1 is a diagram illustrating a basic structure of a power converter according to a first embodiment of the present invention.

FIG. 2 is a diagram illustrating the power converter according to the first embodiment of the present invention.

FIG. 3 is a first diagram for explaining the generation of a recovery current.

FIG. 4 is a second diagram for explaining the generation of a recovery current.

FIG. 5 is a third diagram for explaining the generation of a recovery current.

FIG. 6 is a waveform diagram illustrating the voltage and the current of each of AC switches S1 and S2 illustrated in FIGS. 3 to 5.

FIG. 7 is a first diagram for explaining operation of transistor Q3 in rectifier circuit 1 illustrated in FIG. 1.

FIG. 8 is a second diagram for explaining operation of transistor Q3 in rectifier circuit 1 illustrated in FIG. 1.

FIG. 9 is a third diagram for explaining operation of transistor Q3 in rectifier circuit 1 illustrated in FIG. 1.

FIG. 10 is a first diagram for explaining operation of transistor Q4 in rectifier circuit 1 illustrated in FIG. 1.

FIG. 11 is a second diagram for explaining operation of transistor Q4 in rectifier circuit 1 illustrated in FIG. 1.

FIG. 12 is a third diagram for explaining operation of transistor Q4 in rectifier circuit 1 illustrated in FIG. 1.

FIG. 13 is a diagram for explaining control of power converter 4 illustrated in FIG. 2.

FIG. 14 is a diagram for explaining operation of the rectifier circuit corresponding to each mode illustrated in FIG. 13.

FIG. 15 is a diagram illustrating a power converter according to a second embodiment of the present invention.

FIG. 16 is a diagram illustrating a first configuration example of a power supply device according to a third embodiment of the present invention.

FIG. 17 is a diagram illustrating a second configuration example of the power supply device according to the third embodiment of the present invention.

FIG. 18 is a diagram illustrating a third configuration example of the power supply device according to the third embodiment of the present invention.

### DESCRIPTION OF EMBODIMENTS

Embodiments of the present invention will be described hereinafter, with reference to the drawings. In the drawings, the same or corresponding parts are indicated by the same reference signs, and description thereof will not be repeated.

### First Embodiment

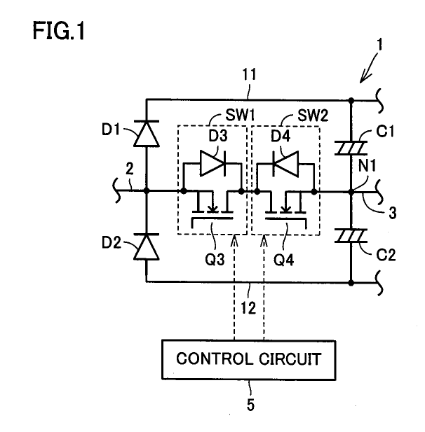

FIG. 1 is a diagram illustrating a basic structure of a power converter according to a first embodiment of the present invention. With reference to FIG. 1, the power converter includes a rectifier circuit 1 and a control circuit 5. Rectifier circuit 1 includes diodes D1, D2, AC switches SW1, SW2, and capacitors C1, C2. Diode D1 has a cathode terminal connected to a DC positive bus 11, and an anode terminal connected to an AC line 2. Diode D2 has a cathode terminal connected to a DC negative bus 12, and an anode terminal connected to AC line 2. In other words, diodes D1, D2 are connected in series in a reverse direction between DC positive bus 11 and DC negative bus 12. AC line 2 is connected to a connection point of diodes D1 and D2.

Capacitor C1 is connected between DC positive bus 11 and neutral point N1. Capacitor C2 is connected between DC negative bus 12 and neutral point N1. That is, neutral point N1 is the connection point of capacitors C1 and C2. A line 3 is connected to neutral point N1. Line 3 is a neutral conductor.

AC switches SW1, SW2 are connected in series between the connection point of diodes D1 and D2 and neutral point N1. AC switch SW1 contains a transistor Q3 and a diode D3. AC switch SW2 contains a transistor Q4 and a diode D4. Each of transistors Q3 and Q4 is a MOSFET. Transistor Q3 is disposed such that current flows in a direction from line 3 toward AC line 2. On the other hand, transistor Q4 is disposed such that current flows from AC line 2 toward line 3.

Diodes D3 and D4 are connected in anti-parallel to transistors Q3 and Q4, respectively. Each of transistors Q3 and Q4 has a parasitic diode (not illustrated). The parasitic diode of transistor Q3 is formed to cause current to flow in the same direction as that of diode D3. The parasitic diode of transistor Q4 is formed to cause current to flow in the same direction as that of diode D4.

Control circuit 5 controls switching of each of transistors Q3 and Q4. In this embodiment, a PWM (Pulse Width Modulation) scheme is employed as a switching scheme for transistors Q3, Q4. AC voltage is supplied to AC line 2. Upon switching of transistors Q3 and Q4, DC voltage is generated between DC positive bus 11 and DC negative bus 12. The voltage of DC positive bus 11 is higher than the voltage of DC negative bus 12.

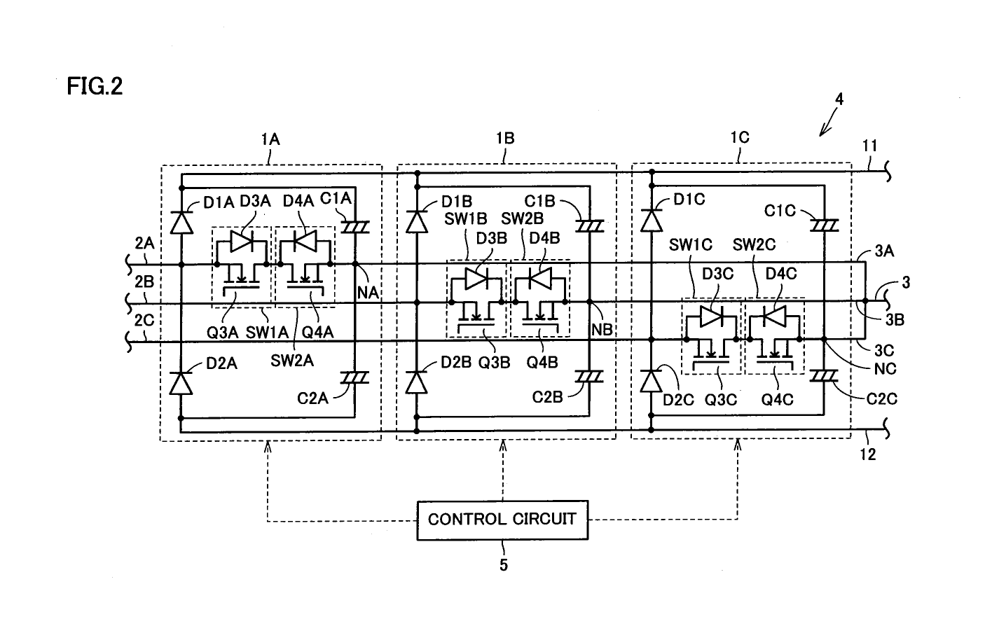

FIG. 2 is a diagram illustrating the power converter according to the first embodiment of the present invention. With reference to FIG. 2, power converter 4 functions as a three-level PWM converter. Power converter 4 includes rectifier circuits 1A, 1B, and 1C, and control circuit 5.

Each of rectifier circuits 1A, 1B, and 1C has the same structure as that of rectifier circuit 1 illustrated in FIG. 1. Thus, each of rectifier circuits 1A, 1B, and 1C has, between DC positive bus 11 and DC negative bus 12, two diodes (D1A and D2A, D1B and D2B, or D1C and D2C) connected in series in the reverse direction, and two capacitors (C1A and C2A, C1B and C2B, or C1C and C2C) connected in series between DC positive bus 11 and DC negative bus 12. Each of neutral points NA, NB, and NC is a connection point of the corresponding two capacitors.

Rectifier circuit 1A further has AC switches SW1A, SW2A connected in series between an AC line 2A and a line 3A. Rectifier circuit 1B further has AC switches SW1B, SW2B connected in series between an AC line 2B and a line 3B. Rectifier circuit 1C further has AC switches SW1C, SW2C connected in series between an AC line 2C and a line 3C. Each of these AC switches has a transistor (MOSFET) and a diode connected in anti-parallel with the transistor.

AC lines 2A, 2B, and 2C are electrically connected to a three-phase AC power supply (not illustrated), for example. Lines 3A, 3B, and 3C are connected to line 3.

Control circuit 5 controls switching of the transistor of each AC switch. As described above, the PWM scheme is employed as the switching scheme for each transistor.

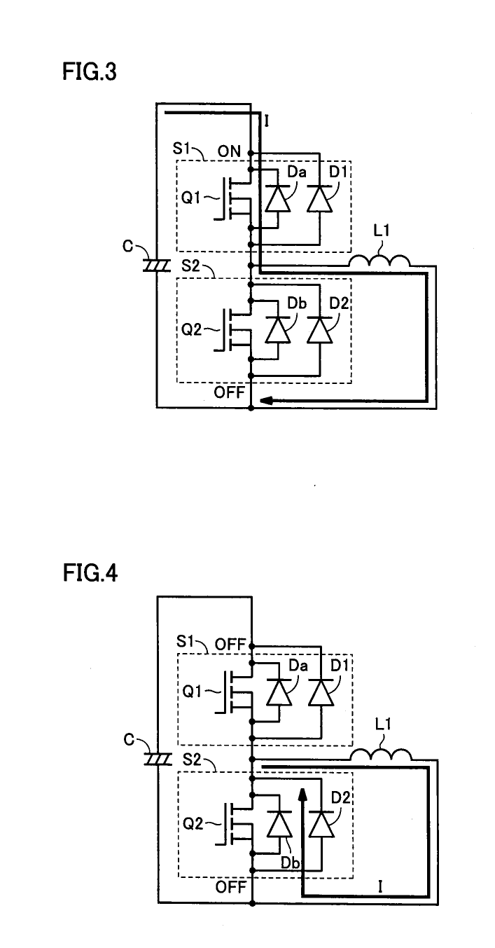

FIG. 3 is a first diagram for explaining the generation of a recovery current. FIG. 4 is a second diagram for explaining the generation of a recovery current. FIG. 5 is a third diagram for explaining the generation of a recovery current.

With reference to FIGS. 3 to 5, AC switches S1 and S2 are connected in series between the two terminals of a capacitor C. AC switch S1 contains a transistor Q1 and diodes Da, D1. AC switch S2 contains a transistor Q2 and diodes Db, D2. Transistors Q1, Q2 are MOSFETs. Diodes Da, Db are parasitic diodes of the MOSFETs. Diodes D1 and D2 are connected in anti-parallel to transistors Q1 and Q2, respectively. Diode Da has the same forward direction as that of diode D1. Diode Db has the same forward direction as that of diode D2.

When AC switch S1 is ON and AC switch S2 is OFF, a current I passes through AC switch S1 (transistor Q1) and reactor L1. Energy is thus stored in reactor L1 (FIG. 3). Next, when AC switch S1 is OFF, the energy stored in reactor L1 is released from reactor L1 as current I. At this time, current I flows through diodes Db and D2 of AC switch S2 (FIG. 4). AC switch S1 subsequently changes from the OFF state to the ON state. At this time, current I passes through AC switch S1 (transistor Q1), and flows through reactor L1, and also flows through diodes Db, D2 (FIG. 5). In the state illustrated in FIG. 5, the current flowing through AC switch S2 is the recovery current.

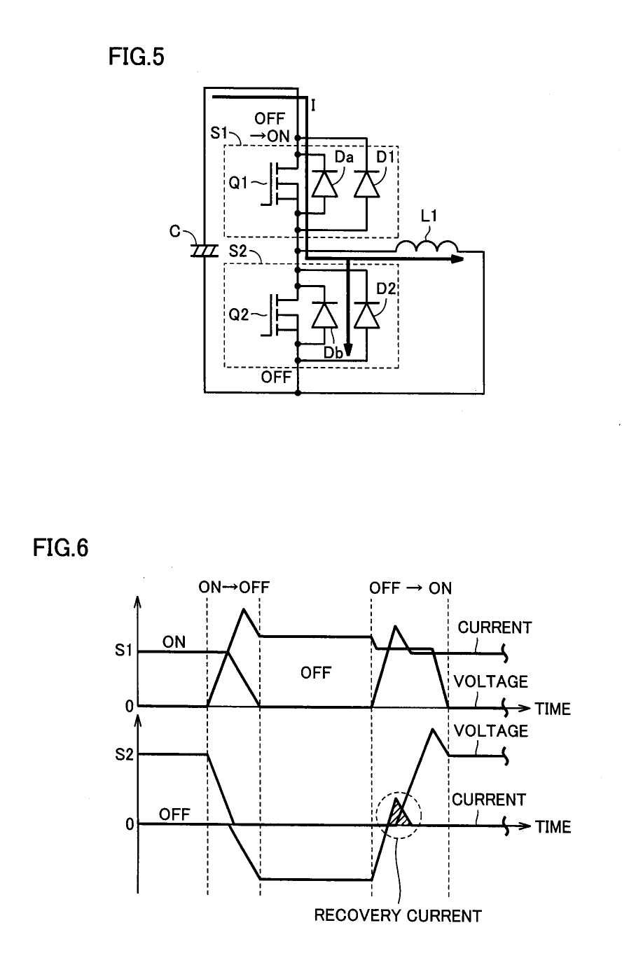

FIG. 6 is a waveform diagram illustrating the voltage and the current of each of AC switches S1 and S2 illustrated in FIGS. 3 to 5. With reference to FIG. 6, when AC switch S1 is in the ON state and AC switch S2 is in the OFF state, the voltage applied to AC switch S1 is zero, and current flows through AC switch S1. At this time, the current flowing through AC switch S2 is zero.

When AC switch S1 changes from the ON state to the OFF state, the voltage applied to AC switch S1 increases, and the voltage flowing through AC switch S1 decreases to zero. On the other hand, with the release of the energy stored in reactor L1, current flows through diodes Db, D2 of AC switch S2. The current in AC switch S2 thus changes from zero to a negative direction.

AC switch S1 subsequently changes from the OFF state to the ON state. In this case, the voltage applied to AC switch S1 decreases to zero, and the current flowing through AC switch S1 increases. On the other hand, in AC switch S2, the current flowing through diodes Db, D2 exceeds the zero axis to become positive, and thereafter decreases to zero. The current in a positive direction surrounded with the broken line is the recovery current. The voltage of AC switch S2 begins to increase during the generation of the recovery current.

As illustrated in FIGS. 3 to 5, MOSFETs (Q1, Q2) have parasitic diodes (Da, Db). The recovery current flowing through diode Db may unintentionally cause the MOSFET (Q2) to be turned ON. In this case, the MOSFET (Q2) may be broken.

Generally, a snubber circuit is used to prevent this problem. Alternatively, wiring with a large width is used. In this embodiment, the flow of the recovery current through the AC switches is avoided.

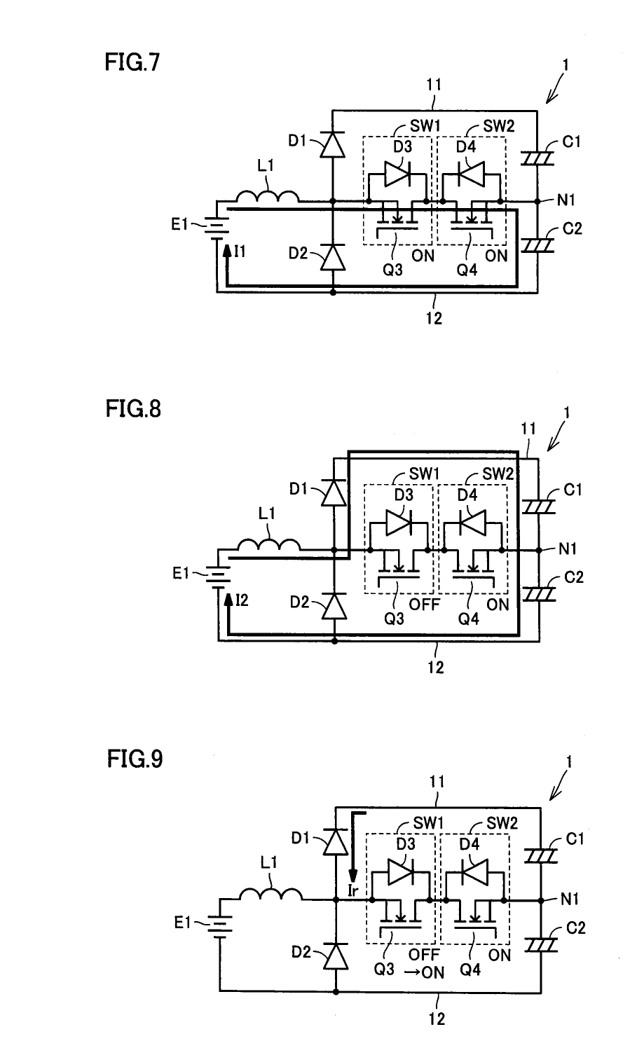

FIG. 7 is a first diagram for explaining operation of transistor Q3 in rectifier circuit 1 illustrated in FIG. 1. FIG. 8 is a second diagram for explaining operation of transistor Q3 in rectifier circuit 1 illustrated in FIG. 1. FIG. 9 is a third diagram for explaining operation of transistor Q3 in rectifier circuit I illustrated in FIG. 1.

With reference to FIGS. 7 to 9, when each of transistors Q3 and Q4 is in the ON state, a current I1 flows from a power supply E1, passes through reactor L1 and transistors Q3, Q4, and returns to power supply E1 (FIG. 7).

Transistor Q3 is next turned OFF. Transistor Q4 remains in the ON state. In this case, a current I2 flows from power supply E1, and passes through diode D1. Current I2 returns to power supply E1 by way of capacitors C1, C2 (FIG. 8).

Transistor Q3 subsequently changes from the OFF state to the ON state. Transistor Q4 remains in the ON state. In this case, a recovery current Ir flows through diode D1 in the reverse direction. No recovery current flows through the parasitic diodes of transistors Q3 and Q4. In the case of the operation of transistors Q1, Q2 illustrated in FIG. 4, a forward current flows through diode Db. Hence, as illustrated in FIG. 5, a recovery current flows through diode Db in the recovery mode. On the other hand, in the operation of transistors Q3, Q4 illustrated in FIGS. 7 and 8, no forward current flowing in the parasitic diodes of transistors Q4, Q3 is generated. Hence, in the recovery mode illustrated in FIG. 9, no recovery current flows through the parasitic diodes.

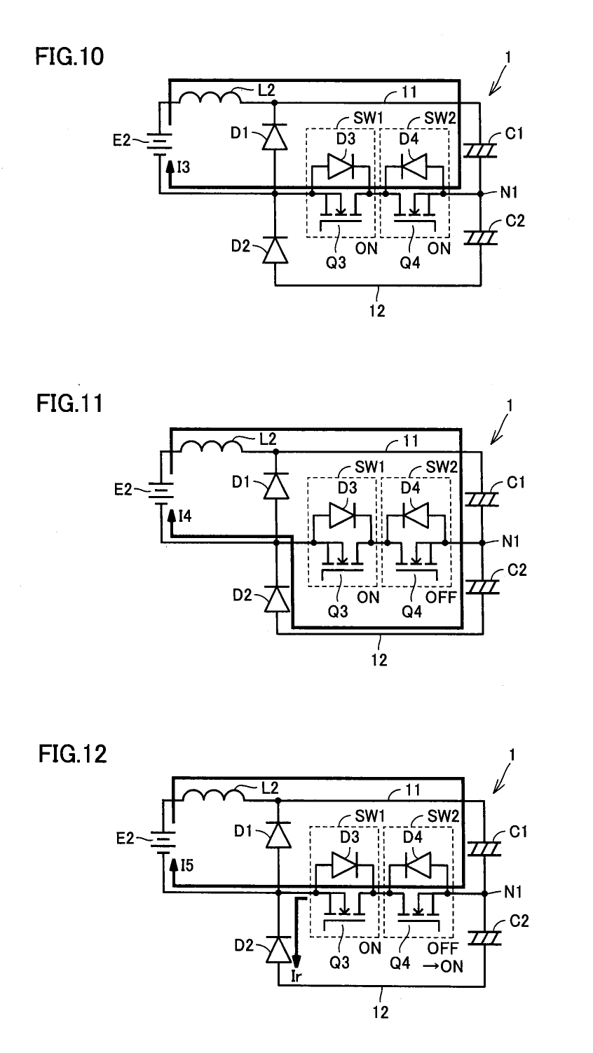

FIG. 10 is a first diagram for explaining operation of transistor Q4 in rectifier circuit 1 illustrated in FIG. 1. FIG. 11 is a second diagram for explaining operation of transistor Q4 in rectifier circuit 1 illustrated in FIG. 1. FIG. 12 is a third diagram for explaining operation of transistor Q4 in rectifier circuit 1 illustrated in FIG. 1.

With reference to FIGS. 10 to 12, where each of transistors Q3 and Q4 is in the ON state, a current I3 flows from a power supply E2, and passes through a reactor L2. A current I3 then passes through transistors Q3, Q4 by way of capacitor C1, and returns to power supply E2 (FIG. 10).

Transistor Q4 is next turned OFF. Transistor Q3 remains in the ON state. In this case, a current I4 flows from power supply E2, and passes through reactor L2. Current I4 then passes through diode D2 by way of capacitors C1, C2, and returns to power supply E2 (FIG. 11).

Transistor Q4 subsequently changes from the OFF state to the ON state. Transistor Q3 remains in the ON state. In this case, a recovery current Ir flows through diode D2 in the reverse direction. Furthermore, a current I5 flows from power supply E2, passes through reactor L2 and transistors Q3, Q4, and returns to power supply E2 (FIG. 12). No recovery current flows through the parasitic diodes of transistors Q3, Q4. This is because no forward current flowing through the parasitic diodes of transistors Q3 and Q4 is generated in the states illustrated in FIGS. 10 and 11.

As illustrated in FIGS. 7 to 9, even though the state of transistor Q3 has changed, no recovery current flows through AC switches SW1, SW2. Likewise, as illustrated in FIGS. 10 to 12, even though the state of transistor Q4 has changed, no recovery current flows through AC switches SW1, SW2.

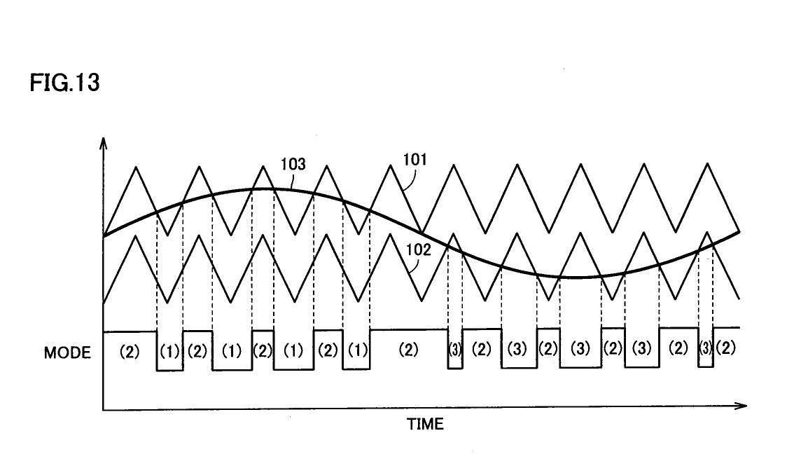

FIG. 13 is a diagram for explaining control of power converter 4 illustrated in FIG. 2. With reference to FIG. 13, the control of rectifier circuits 1A, 1B, and 1C is the same. FIG. 13 thus illustrates control of any one of rectifier circuits 1A, 1B, and 1C. Control circuit 5 compares a voltage command signal 103 with reference signals 101, 102. Reference signals 101, 102 and a voltage command signal 103 are generated by control circuit 5. Voltage command signal 103 is a sinusoidal signal. The frequency of voltage command signal 103 is equal to the frequency of AC power (50 Hz or 60 Hz, for example). On the other hand, each of reference signals 101 and 102 is a triangular wave signal. The frequency of each of reference signals 101 and 102 is about 1 kHz to about 10 kHz, for example.

A mode (1) corresponds to a state in which voltage command signal 103 is greater than reference signal 101. A mode (2) corresponds to a state in which voltage command signal 103 is greater than reference signal 102 and smaller than reference signal 101. A mode (3) corresponds to a state in which voltage command signal 103 is smaller than reference signal 102.

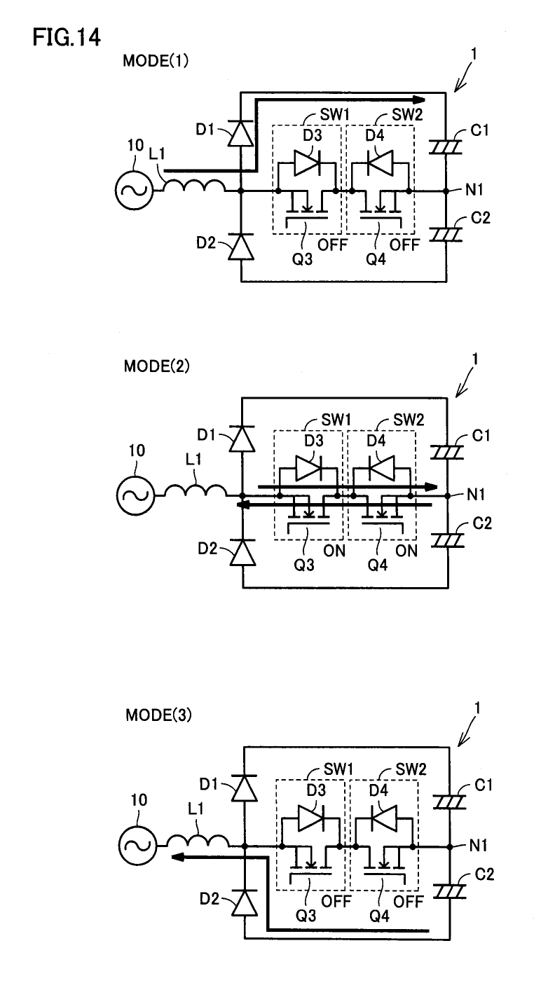

FIG. 14 is a diagram for explaining operation of the rectifier circuit corresponding to each mode illustrated in FIG. 13. As described above, the control of rectifier circuits 1A, 1B, and 1C is the same. FIG. 14 thus illustrates rectifier circuit 1 as any one of rectifier circuits 1A, 1B, and 1C. With reference to FIG. 14, transistors Q3 and Q4 are both turned OFF in mode (1). In this case, current passes from an AC power supply 10 through reactor L1 and diode D1, and flows into capacitor C1.

In mode (2), transistors Q3 and Q4 are both turned ON. In this case, current flows in a direction from neutral point N1 toward a connection point of diodes D1, D2. Alternatively, current flows in a direction from the connection point of diodes D1, D2 toward neutral point N1.

In mode (3), transistors Q3 and Q4 are both turned OFF. In this case, current passes from capacitor C2 through diode D2, and flows into AC power supply 10. In any mode of modes (1) to (3), the flow of recovery current through AC switches SW1, SW2 can be prevented.

Power converter 4 (PWM converter) illustrated in FIG. 2 is a three-level circuit. Power converter 4 is thus capable of converting AC voltage having three values into DC voltage. The application of the three-level circuit to the PWM converter can reduce a ripple component generated in a reactor (reactor L1 in FIG. 14, for example). Since the ripple component is small, the reactor may have a small inductance. The reactor can thus be reduced in size. Since the reactor can be reduced in size, a reduction in size and weight of the power converter can be achieved.

Generally, in order to realize a three-level circuit, four switching elements connected in series between a DC positive bus and a DC negative bus are required (see WO 2010/021052 A1, for example). According to this embodiment, a three-level circuit can be realized with two switching elements. For this reason, a reduction in size and weight of the power converter can be achieved.

Furthermore, according to this embodiment, no recovery current flows through the AC switches. Where the AC switches are MOSFETs, breakage of the MOSFETs due to recovery current can be prevented. MOSFETs can therefore be used for the AC switches. Generally, when a MOSFET and an IGBT having an equal rating are compared, switching loss in the MOSFET is smaller than that in the IGBT. Loss can be reduced by applying MOSFETs to the AC switches. In this way, a power converter having high efficiency can be realized.

### Second Embodiment

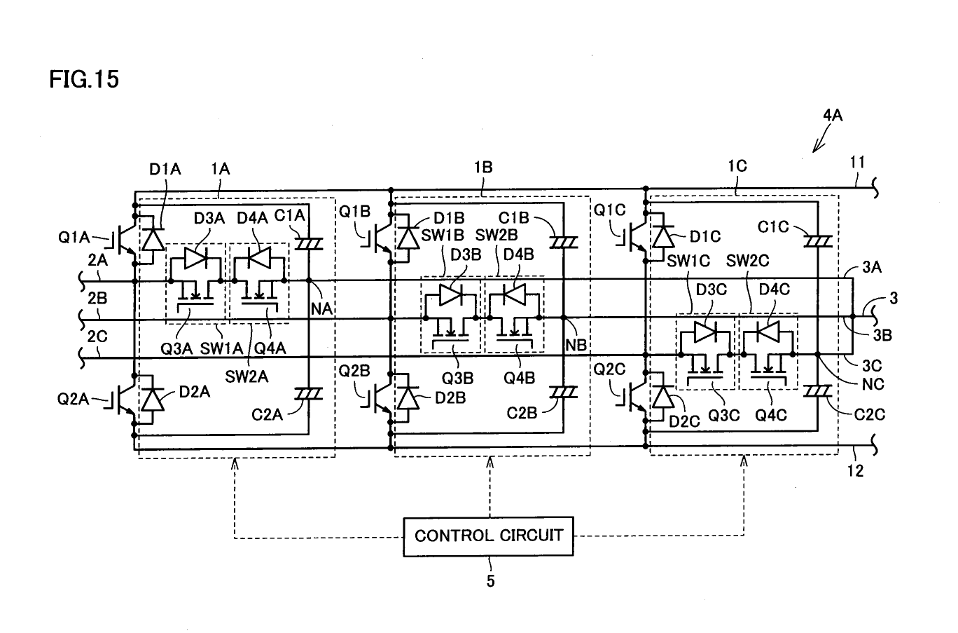

FIG. 15 is a diagram illustrating a power converter according to a second embodiment of the present invention. With reference to FIG. 15, a power converter 4A includes, in addition to rectifier circuits 1A, 1B, and 1C, transistors Q1A, Q2A, Q1B, Q2B, Q1C, and Q2C. The structure of each of rectifier circuits 1A, 1B, and 1C is the same as the structure illustrated in FIG. 2.

Each of transistors Q1A, Q2A, Q1B, Q2B, Q1C, and Q2C is an IGBT. Transistors Q1A, Q2A are connected in series between DC positive bus 11 and DC negative bus 12. Transistors Q1B, Q2B are connected in series between DC positive bus 11 and DC negative bus 12. Transistors Q1C, Q2C are connected in series between DC positive bus 11 and DC negative bus 12. Control circuit 5 controls switching of transistors Q1A, Q2A, Q1B, Q2B, Q1C, and Q2C.

In the structure illustrated in FIG. 15, diodes D1A and D2A are connected in anti-parallel to transistors Q1A and Q2A, respectively. Diodes D1B and D2B are connected in anti-parallel to transistors Q1B and Q2B, respectively. Diodes D1C and D2C are connected in anti-parallel to transistors Q1C and Q2C, respectively.

Generally, a PWM converter has a power factor of near 1.0. Hence, substantially no current flows in transistors Q1A, Q2A, Q1B, Q2B, Q1C, and Q2C. For this reason, in power converter 4 (PWM converter) illustrated in FIG. 2, transistors Q1A, Q2A, Q1B, Q2B, Q1C, and Q2C are omitted from the structure illustrated in FIG. 15.

Power converter 4A has rectifier circuits 1A, 1B, and 1C according to the first embodiment. According to this embodiment, therefore, the same effects as those with the power converter according to the first embodiment can be achieved.

Furthermore, according to this embodiment, an arm is configured with the two transistors connected in series between DC positive bus 11 and DC negative bus 12. For example, where a three-phase AC motor is connected to AC lines 2A, 2B, and 2C, regenerative operation of the three-phase AC motor can be performed. That is, power converter 4A can convert AC power generated by the regenerative operation of the three-phase AC motor into DC power.

### Third Embodiment

A power supply device according to a third embodiment can be realized with the power converter according to the first or second embodiment.

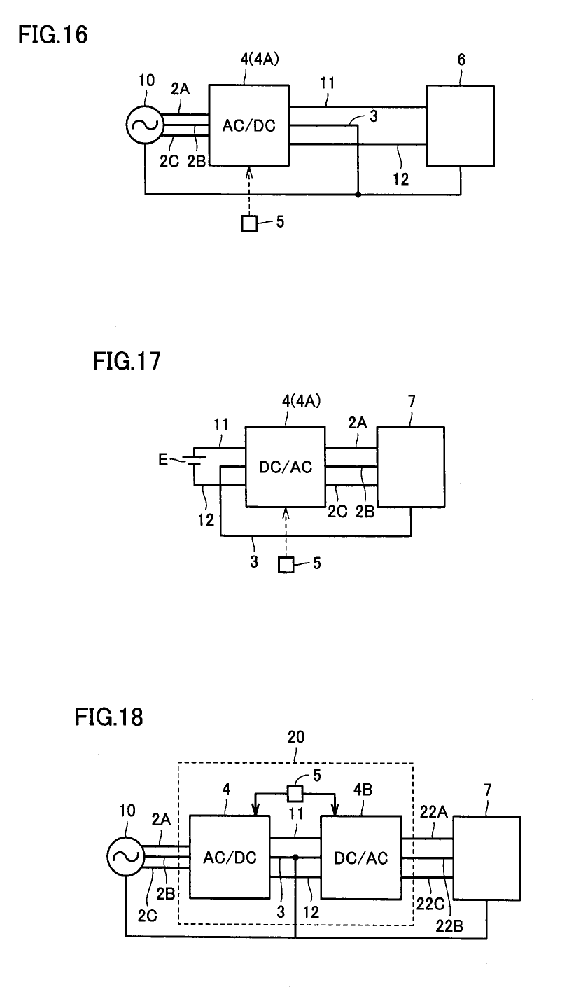

FIG. 16 is a diagram illustrating a first configuration example of the power supply device according to the third embodiment of the present invention. With reference to FIG. 16, power converter 4 (or 4A) converts three-phase AC power from AC power supply 10 into DC power. Power converter 4 (or 4A) supplies the DC power to a DC load 6 by way of DC positive bus 11 and DC negative bus 12. Line 3 is connected to AC power supply 10 and DC load 6.

FIG. 17 is a diagram illustrating a second configuration example of the power supply device according to the third embodiment of the present invention. With reference to FIG. 17, power converter 4 (or 4A) converts DC power from a DC power supply E into three-phase AC power. DC positive bus 11 and DC negative bus 12 are connected to DC power supply E. Power converter 4 (or 4A) supplies the three-phase AC power to an AC load 7 by way of AC lines 2A, 2B, and 2C. AC load 7 is a three-phase four-wire system load. Line 3 is connected to AC load 7. As illustrated in FIG. 17, power converter 4 (or 4A) can be used not only as a converter but also as an inverter (three-level PWM inverter). Where AC load 7 is a three-phase AC motor, power converter 4A is preferably used. Power converter 4A can convert the AC power generated by the regenerative operation of the three-phase AC motor into DC power, and supply the DC power to DC power supply E.

FIG. 18 is a diagram illustrating a third configuration example of the power supply device according to the third embodiment of the present invention. With reference to FIG. 17, a power supply device 20 contains power converter 4 and a power converter 4B. Power converter 4B has the same structure as the structure of power converter 4. Power converter 4 converts the three-phase AC power from AC power supply 10 into DC power. Power converter 4B converts the DC power from power converter 4 into three-phase AC power, and supplies the three-phase AC power to an AC load 7 by way of AC lines 22A, 22B, and 22C. AC load 7 is a three-phase four-wire system load. Line 3 is connected to AC power supply 10 and AC load 7.

In the structure of FIG. 18, a power converter 4A can be used instead of power converter 4. In this case, power converter 4B has the same structure as the structure of power converter 4A, for example.

The embodiments disclosed here should be understood as being illustrative rather than being limitative in all respects. The scope of the present invention is shown not in the foregoing description but in the claims, and it is intended that all modifications that come within the meaning and range of equivalence to the claims are embraced here.

### REFERENCE SIGNS LIST

1, 1A-1C: rectifier circuit; 2, 2A-2C, 22A-22C: AC line; 3, 3A-3C: line (neutral conductor); 4, 4A, 4B: power converter; 5: control circuit; 6: DC load; 7: AC load; 10: AC power supply; 11: DC positive bus; 12: DC negative bus; 20: power supply device; 101, 102: reference signal; 103: voltage command signal; C, C1, C2: capacitor; D1-D4, D1A, D2A, D1B, D2B, D1C, D2C, Da, Db: diode; E: DC power supply; E1, E2: power supply; I, I1-I5: current; Ir: recovery current; L1, L2: reactor; N1, NA-NC: neutral point; Q1-Q4, Q1A, Q2A, Q1B, Q2B, Q1C, Q2C: transistor; S1, S2, SW1, SW2, SW1A, SW2A, SW1B, SW2B, SW1C, SW2C: AC switch.

1. A power converter comprising:
a first diode having a cathode terminal connected to a DC positive bus;
a second diode having a cathode terminal connected to an anode terminal of said first diode, and an anode terminal connected to a DC negative bus;
a first capacitor connected between said DC positive bus and a neutral point;
a second capacitor connected between said DC negative bus and said neutral point; and
an AC switch connected between a connection point of said first and second diodes, and said neutral point.

2. The power converter according to claim 1, wherein
said AC switch includes:
first and second MOSFETs connected in series between said connection point of said first and second diodes, and said neutral point;
a third diode connected in anti-parallel to said first MOSFET; and
a fourth diode connected in anti-parallel to said second MOSFET.

3. The power converter according to claim 2, further comprising:
first and second semiconductor switching elements connected in series between said DC positive bus and said DC negative bus, wherein
said first diode is connected in anti-parallel to said first semiconductor switching element, and
said second diode is connected in anti-parallel to said second semiconductor switching element.

4. The power converter according to claim 2, wherein
said connection point of said first and second diodes is connected to an AC line, and
said power converter further comprises a control circuit for controlling said first and second MOSFETs such that AC voltage supplied via said AC line is converted into DC voltage.

5. The power converter according to claim 2, wherein
said connection point of said first and second diodes is connected to an AC line, and
said power converter further comprises a control circuit for controlling said first and second MOSFETs such that DC voltage supplied via said DC positive bus and said DC negative bus is converted into AC voltage.
